(19) United States
(12) Patent Application Publication
(10) Pub. No.: US 2008/0243668 A1
(43) Pub. Date: Oct. 2, 2008

(54) AUTHORIZATION CONTROL SYSTEM AND METHOD TO DETERMINE OPERATION OF A CONTROLLED DEVICE TO PERMIT AN INDIVIDUAL TO PERFORM AN ACTION

(76) Inventors: Nathan Ondyak, New York, NY (US); Bernie Weinstein, New York, NY (US); Franz Archibald, New York, NY (US); Michael Semegran, New York, NY (US); Dean P. Alderucci, New York, NY (US); Geoffrey M. Gelman, New York, NY (US)

Correspondence Address: DEAN P. ALDERUCCI, CANTOR FITZGERALD, L.P., 110 EAST 59TH STREET (6TH FLOOR), NEW YORK, NY, 10022, US

(21) Appl. No.: 11/694,642

(22) Filed: Mar. 30, 2007

(51) Int. Cl. G06Q 40/00; G06F 17/00

(52) U.S. Cl. 705/37; 705/400

(57) ABSTRACT

At least one price may be determined for an asset and a classification determined for the price in which the classification may include, for example, an indication of how reflective the determined price may be of a market value of the asset.

### TERMS

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### Disclosed Examples and Terminology are not Limiting

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. § 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### 35 U.S.C. 112, Paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function. Also includes a computing device (e.g., a general purpose computer) that is programmed and/or configured with appropriate hardware to perform that function via other algorithms as would be understood by one of ordinary skill in the art.

### Disclaimer

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in the present application shall be prefaced by the phrase “does not include” or by the phrase “cannot perform”.

### Incorporation by Reference

Any patent, patent application or other document referred to herein is incorporated by reference into this patent application as part of the present disclosure, but only for purposes of written description in accordance with 35 U.S.C. § 112, paragraph 1 and enablement in accordance with 35 U.S.C. § 112, paragraph 1, and should in no way be used to limit, define, or otherwise construe any term of the present application where the present application, without such incorporation by reference, would not have failed to provide an ascertainable meaning, but rather would have allowed an ascertainable meaning for such term to be provided. Thus, the person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### BRIEF DESCRIPTION OF THE FIGURES

FIG. 1 shows an example procedure for determining a price of an asset and a classification for the price according to an embodiment of the invention.

FIG. 2 shows an example system for determining and making available prices of assets and classifications for the prices according to an embodiment of the invention.

### DETAILED DESCRIPTION

According to an embodiment of the invention, a price or value (hereinafter collectively referred to as a price) may be determined for an asset and a classification determined for and/or assigned to the price, in which the classification may be from a plurality (e.g., two or more) of classifications that make up a classification system, for example. According to an embodiment of the invention, the determined classification may include an indication of how reflective the determined price is of a market value of the asset. Alternatively, the determined classification may include an indication of how accurate the determined price is compared to a market value of the asset. According to an embodiment of the invention, the plurality of classifications that make up a classification system may have a ranked order. Accordingly, each of the plurality of classification may include, for example, an increasing indication of how reflective a determined price is of a market value of an asset. For example, one extreme of the plurality of classifications may indicate that a determined price is highly reflective of a market value of an asset while the opposing extreme of the plurality of classifications may indicate that a determined price is minimally reflective of a market value of an asset. As such, according to an embodiment of the invention, a price may be determined for an asset and the price then assigned one of a plurality of classifications with the assigned classification including, for example, an indication of how reflective the determined price is of a market value of the asset.

According to an embodiment of the invention, a given classification system may be a generic system such that for any given asset and a determined price for that asset, the price may be assigned one of a plurality of classifications making up the classification system. According to another embodiment of the invention, a classification system may be specific system, such as to a given type and/or class of assets. For example, a first classification system may be used for assets that include financial instruments while a second classification system may be used for assets that include real property, such as buildings, homes, etc.

According to an embodiment of the invention, a market value as referred to by a given classification system may include a fair market value of an asset. The fair market value of an asset may include, for example, the most probable price at which the asset may transfer between a buyer and seller in a free and open market assuming i) the seller is knowledgeable, is willing to sell, is unencumbered by undue pressure to sell, and is acting in his/her own best interest, ii) the buyer is knowledgeable, is willing to buy, is unencumbered by undue pressure to buy, and is acting in his/her own best interest, and iii) the asset is exposed to the market for a reasonable time. As such, each of a plurality of classifications making up a classification system may include, for example, an increasing indication of how reflective a determined price is of a fair market value of an asset. One skilled in the art will recognize that not all assets may have a fair market value, such as for example, one-of-a-kind assets.

According to another embodiment of the invention, a market value as referred to by a given classification system may include a most probable price at which an asset could be purchased and/or sold in a liquid market for that asset.

According to another embodiment of the invention, a market value as referred to by a given classification system may include a most probable price at which an asset could be purchased and/or sold in a specific market, such as a specific exchange (e.g., the NYSE), a specific over-the-counter market, a specific electronic communication network and/or electronic commerce network (hereinafter collectively referred to as ECN), a specific web site (e.g., ebay), a specific auction, etc.

According to a further embodiment of the invention, a market value as referred to by a given classification system may include a most probable price at which an asset could be purchased and or sold at a foreclosure sale, a liquidation sale, etc.

According to another embodiment of the invention, a market value as variously described above, for example, may include a current market value, a historic market value (e.g. with respect to a previous day, month, year), a market value with respect to a U.S. market, and/or a market value with respect to a market foreign to a U.S. market, etc.

One skilled in the art will recognize that a classification system may refer other types of market values than those discussed herein.

One skilled in the art will also recognize that a classification system may include an indication of something other than a market value of an asset. For example, a classification system may include an indication as to an extent to which (e.g., a probability or likelihood) an asset can be purchased and/or sold at the determined price. As another example, assuming a classification system includes a plurality of ranked ordered classifications and that a first entity is providing a determined price to a second entity that is seeking to buy and/or sell the asset from/to the first entity, one extreme of the plurality of classifications may indicate that a determined price is a firm or tradable price (e.g., a price at which the first entity is committed to purchase and/or sell the asset to the second entity) while the opposing extreme of the plurality of classifications may indicate that a determined price is an indicative price (e.g., a price estimate from which the first entity is willing to further negotiate). Classifications there between (i.e., from the opposing extreme to the other) may indicate that a determined price may be considered an increasingly more firm/tradable price.

According to an embodiment of the invention, each of a plurality of classifications of a classification system may be a discrete value or category (e.g., a classification system may include a discrete set of values such as: 1, 2, 3, . . . , 5.) According to another embodiment of the invention, a plurality of classifications may be a contiguous range of values or a contiguous/inclusive set of values (e.g., a classification system may include a contiguous range of values such as: 1-5, inclusive). One skilled in the art will recognize that a plurality of classifications may have other forms, such as a combination of discrete categories, with one or more categories including a contiguous range or a contiguous set of values.

According to various embodiments of the invention, a plurality of classifications of a classification system may be expressed in various ways. For example, according to an embodiment of the invention a plurality of classifications may be expressed separate from the price being classified. For example, each classification may be a numeric, an alphabetic, and/or an alphanumeric value such as i) 1, 2, 3, etc, ii) A, B, C, etc iii) A, AA, AAA, B, BB, etc, iv) A+, A, A−, B+, B, etc., v) “worst”, “bad”, “good,” “better,” and “best”, vi) “Tier 1”, “Tier 2”, “Tier 3”, “Tier 4”, “Tier 5”. As another example, each classification may be a different symbol type value. As a further example, each classification may be a different color on a contiguous and/or non contiguous color scale. As another example, each classification may be an audible sound on a contiguous and/or non-contiguous audible scale.

According to another embodiment of the invention, a plurality of classifications of a classification system may be expressed as part of the price being classified. For example, a price may be shown in a different font, color, and/or size, with each font, color, and/or size indicating a classification. According to a further embodiment of the invention, the plurality of classifications may be expressed as a combination of being separate from the price being classified and part of the price being classified. One skilled in the art will recognize that a plurality of classifications may be expressed in other ways.

According to an embodiment of the invention, an asset for which a price may be determined may be a real property (e.g., land, a home, a building; etc.) and/or personal property, including tangible property (e.g., a car, jewelry, consumer electronics; etc.) and/or intangible property (e.g., a financial instrument, intellectual property such as a trade secret, a patent, or a copyright, a service, a reservation, a ticket such as a sporting event or concert ticket, etc.). One skilled in the art will recognize that the noted examples of real and personal property are merely examples and that an asset may be any type of real property, personal property, or combinations thereof.

According to one example embodiment of the invention, an asset for which a price and corresponding classification may be determined may be any financial instrument such as an equity instrument (e.g., stock, etc.), a debt instrument (e.g., a fixed income security, a loan such as a mortgage, commercial paper such as a promissory note, draft, check, or certificate of deposit, etc.), a foreign exchange instrument (e.g., a spot foreign exchange, etc.), a commodity, an insurance policy, an instrument based on one or more underlying instruments such as a derivative instrument (e.g., a derivative instrument based on an equity instrument, a debt instrument, a commodity, an exchange rate, an interest rate, an index, etc.). One skilled in the art will recognize that the foregoing are merely examples of financial instruments and that an asset may be any other type of financial instrument and combinations thereof.

According to an embodiment of the invention, a financial instrument for which a price and corresponding classification may be determined may include a quantity or size, such as a quantity of stock.

According to an embodiment of the invention, a price of an asset (also referred to hereinafter as a first asset) may be determined and/or computed from market data and a classification, from a plurality of classifications, determined and/or computed for the price based on one or more criteria applied to the market data.

In particular, with respect to the determination of a price, according to one embodiment of the invention, a price of a first asset may be determined and/or computed from market data that includes one or more trade, or selling, or transaction prices (hereinafter collectively referred to as trade prices) at which a second asset(s) sold and in which the first and second assets may be fungible (e.g., interchangeable, or substitutable, or identical). (One skilled in the art will also recognize that the trade prices may also be from one or more sales of the first asset itself. Accordingly, while descriptions herein may be made to market data on a second asset, one skilled in the art should recognize that the market data may also be on the first asset itself.) In general, the size/quantity of the first asset and the second asset(s) may differ. According to one embodiment of the invention, the first and second assets may be financial instruments. For example, the first and second assets may be the same or differing quantities of shares of stock for a “company A”.

According to an embodiment of the invention, the one or more trade prices of the second asset(s) may come from one or more sources and in particular, may be trade prices from one or more markets. A market may include any forum in which an asset may be purchased and/or sold, such as an auction, a web site, etc. In the context of financial instruments, for example, a market may include, for example, a primary exchange (e.g., a main exchange on which a given asset is listed), one or more secondary exchanges (e.g., an exchange other than an asset's primary exchange), one or more over-the-counter markets (which may include, for example, any transaction between dealers, between dealers and brokers, between investors and dealer/brokers, between investors, etc.), and/or one or more ECNs, etc. One skilled in the art will recognize that other sources of market data are possible.

According to an embodiment of the invention, the one or more trade prices may come from various times. For example, any of the one or more trade prices may be a current trade price. A current trade price may include, for example, a last trade price for a given asset that occurred in a given market. Alternatively, a current trade price may include, for example, any trade price for a given asset that occurred any time in the past “W” seconds, minutes, hours, days, etc. in a given market. As another example, the one or more trade prices may include historic trade prices. A historic trade price may include, for example, a trade price other than a last trade price for a given asset in a given market. Alternatively, a historic trade price may include, for example, any trade price for a given asset in a given market that occurred prior to a specified point in time.

One skilled in the art will recognize that a price of the first asset may be determined in various ways from the one or more trade prices of the second asset(s). For example, the price of the first asset may be computed as a single trade price for the second asset or computed as some combination of multiple trade prices for the second asset(s), such as a weighted average of prices based on varying quantities of the second asset sold, for example.

According to another embodiment of the invention, a price of a first asset may be determined and/or computed from market data that includes one or more quotes of a second asset(s), in which the first and second assets may be fungible. (Again, one skilled in the art will also recognize that the quotes may also be from and/or on the first asset itself. Accordingly, while descriptions herein may be made to market data on a second asset, one skilled in the art should recognize that the market data may also be on the first asset itself.) As described above, the size/quantity of the first and second assets may be the same and/or differ. According to one embodiment of the invention, the first and second assets may be financial instruments.

According to various embodiments of the invention, the one or more quotes may include one or more bid prices and/or one or more ask prices. The one or more quotes may include one or more best bid prices, one or more best ask prices, and/or one or more bid prices and/or ask prices that are not best bid and ask prices. The one or more quotes may include one or more live quotes (e.g., quotes that may be acted upon or in other words, hit and/or taken) and/or one or more cancelled quotes. The one or more quotes may include one or more real and/or firm quotes (hereinafter referred to as real quotes) and/or one or more indicative and/or nominal quotes (hereinafter referred to as indicative quotes).

As similarly described above, the one or more quotes of the second asset(s) may come from the same or multiple sources, such as one or more markets. In addition, the one or more quotes may come from various times. For example, any of the one or more quotes may be a current quote. A current quote may include, for example, a live quote for a given asset in a given market. Alternatively, a current quote may include, for example, any quote for a given asset that occurred any time in the past “W” seconds, minutes, hours, days, etc. in a given market. As another example, the one or more quotes may include historic quotes. A historic quote may include, for example, a cancelled quote and/or quote that has been hit or taken for a given asset in a given market. Alternatively, a historic quote may include, for example, any quote for a given asset in a given market that occurred prior to a specified point in time.

One skilled in the art will recognize that a price of the first asset may be determined in various ways from one or more quotes of the second asset(s). For example, the price of the first asset may be computed as a single best bid price for the second asset, a single best ask price for the second asset, as an average of a best bid and best ask prices for the second asset, etc.

According to another embodiment of the invention, a first asset may be based on one or more underlying assets. For example, the first asset may be a derivative and the underlying asset may be one or more financial instruments, such as an equity instrument (for ease of description, it will be assumed the first asset is based on a single underlying asset). According to an embodiment of the invention, a price of the first asset may be determined and/or computed from market data that includes one or more trade prices for a second asset(s), such as a financial instrument(s), in which the second asset(s) and the underlying asset may be fungible. (Again, one skilled in the art will also recognize that the trade prices may also be from one or more sales of the underlying asset itself. Accordingly, while descriptions herein may be made to market data on a second asset, one skilled in the art should recognize that the market data may also be on the underlying asset itself.) Again, the size/quantity of the second and underlying assets may be the same and/or differ. As similarly described above, the one or more trade prices of the second asset(s) may come from the same or multiple sources and may come from various times. One skilled in the art will recognize that a price of the first asset may be determined in various ways from the one or more trade prices of the second asset(s). For example, the one or more trade prices may be used to determine a price for the underlying asset, and the determined price for the underlying asset then used to determine a price for the first asset using known relationships on how a price of the first asset tracks a price of the underlying asset.

According to another embodiment of the invention, for a first asset that may be based on an underlying asset(s), a price of the first asset may be determined and/or computed from market data that includes one or more quotes for a second asset(s), in which the second asset(s) and the underlying asset may be fungible. (Again, one skilled in the art will also recognize that the quotes may also be from and/or on the underlying asset itself.) As described above, the size/quantity of the second and underlying assets may be the same or differ. According to one embodiment of the invention, the first, second, and underlying assets may be financial instruments. As similarly described above, the one or more quotes may come from the same or multiple sources and from various times. One skilled in the art will recognize that a price for the asset may be determined in various ways from the one or more quotes for the second asset(s). For example, the one or more quotes may be used to determine a price for the underlying asset, and the determined price for the underlying asset then used to determine a price for the first asset using known relationships on how a price of the first asset tracks a price of the underlying asset.

According to another embodiment of the invention, a first asset may be related to and/or similar to a second asset(s) such that a price of the first asset may be determined and/or computed from market data for the second asset(s). As described above, the size/quantity of the first and second assets may be the same or differ. According to an embodiment of the invention, the first and second assets may include one or more financial instruments.

According to various embodiments of the invention, the first and second assets may be related and/or similar in various ways. For example, in the context of financial instruments, the first and second assets may have a similar cash flow, a similar average and/or historic return over a give period, a similar expected return, a similar volatility, a similar historic price trend, and/or a similar risk. As another example, the first and second assets may have respective underlying entities that are similar and/or related in some fashion. For example, the underlying entities may be the same entity, may be in the same or related industries, may operate in the same or related countries and/or geographic regions, and/or one entity may own the other entity or be expected to purchase or merge with the other entity, etc. One skilled in the art will recognize that the first and second assets may be related and/or similar in other fashions.

According to an embodiment of the invention, a price of the first asset may be determined and/or computed from market data that includes one or more trade prices for the second asset(s). As similarly described above, the one or more trade prices may come from the same or multiple sources and may come from various times. According to another embodiment of the invention, a price of the first asset may be determined and/or computed from market data that includes one or more quotes for the second asset(s). As similarly described above, the one or more quotes may come from the same or multiple sources and from various times. One skilled in the art will recognize that a price for the first asset may be determined in various ways from the one or more trade prices or quotes of the second asset(s). For example, the one or more trade prices or quotes may be used as and/or to determine a price for the second asset(s), and the determined price for the second asset(s) then used to determine a price for the first asset using a known relationship(s) on how a price of the first asset tracks a price of the second asset(s).

According to another embodiment of the invention, a price of a first asset may be determined and/or computed by applying to one or more models market data of the first asset and/or of an asset underlying the first asset and/or of one or more second assets. According to an embodiment of the invention, the first, second, and underlying assets may include one or more financial instruments. Accordingly, the market data may be applied to one or more financial models. According to an embodiment of the invention, mark to model may be used to determine the price of the first asset. According to various embodiments of the invention, the second asset(s) and the first asset may be fungible, the second asset(s) and an underlying asset to the first asset may be fungible, and/or the second asset(s) may be related to the first asset, as similarly described above. The market data may include one or more trade prices and/or one or more quotes, as described above, and may be from one or more sources, as described above. The market data may include current market data and/or historic market data, as described above. According to an embodiment of the invention, the market data may include historical spreads. One skilled in the art will recognize that any given model may also require additional data, such as current economic events and/or conditions.

One skilled in the art will recognize that the price of a first asset may be determined from market data in additional ways than those described above, including one or more combinations of the above described ways. One skilled in the art will also recognize that a price of a first asset may be determined in ways that may or may not use market data and that such additional ways are also applicable to various embodiments of the present invention.

Referring now to a determination and/or computation of a classification (from among a plurality of classifications) for a price of an asset, according to an embodiment of the invention, one or more criteria and/or conditions and/or tests and/or attributes (hereinafter collectively referred to as one or more criteria) may be defined, which criteria may used to determine and/or compute the classification. For example, according to an embodiment of the invention, one or more criteria may be used to measure a quality of the market data that was used to determine a price of an asset such that higher quality market data may result in a determined price with a higher classification (e.g., a price that is more indicative of a market value of an asset) as compared to lower quality market data. According to various embodiments of the invention, to determine a classification, one or more criteria may be compared against the market data, and/or the criteria may be used to analyze the market data, and/or the criteria may be applied to the market data. One skilled in the art will recognize that while multiple criteria may be defined, all or fewer than all of the defined criteria may be needed and/or used to determine a classification.

One skilled in the art will also recognize that the criteria may be used in different fashions to determine a classification. For example, the criteria may be used in a linear fashion, with a first criteria resulting in the determination of a classification or resulting in a second criteria being analyzed, which may in turn result in the determination of a classification or a third criteria being analyzed, etc. One skilled in the art will recognize that each criteria may result in the determination of a different classification and/or two or more criteria may result in the determination of a same classification. As another example, the criteria may be used in tree-like fashion, with a first criteria resulting in the determination of a classification and/or resulting in a second or third criteria being analyzed, etc. Again, one skilled in the art will recognize that each criteria may result in the determination of a different classification and/or two or more criteria may result in the determination of a same classification. As another example, both a combination of a linear and a tree-like arrangement may be used. As another example, a first criteria may result in an initial determination of a classification, with a second criteria and possibly a third, etc. then being used to refine and/or adjust the classification. One skilled in the art will also recognize that depending, for example, on the defined criteria, there may be a definitive order as to which criteria may be analyzed first, second, etc., or there may be no definitive order, or some combination thereof. According to another embodiment of the invention, the criteria may be used in a formulaic arrangement. For example, one or more criteria may be applied to the market data, with each criteria resulting in a value. The resulting values may then be combined (e.g., added) into a single score, which may represent a classification and/or be used to determine a classification. According to another embodiment of the invention, for a price to obtain a particular classification (or, for example, to fall into a particular category), the market data may need to satisfy one or more criteria defined for that classification. One skilled in the art will recognize that regardless of how one or more criteria are used to determine a classification, the criteria may be equally weighted and/or have different weights. One skilled in the art will recognize that one or more criteria may be used to determine a classification in ways other than those described herein.

Following below is a list of example criteria according to various embodiments of the invention that may be used to determine a classification of a price, and also examples of how each criteria may affect the determination of a classification. One skilled in the art will recognize, however, that additional criteria may be defined and that each of the defined criteria may affect the determination of a classification in a different way. One skilled in the art will also recognize that one or more of the listed criteria may be arranged and/or used as described above.

According to an embodiment of the invention, a first criteria for determining a classification for a price of a first asset may include a relationship of the market data to the asset. For example, as described above, the price of a first asset may be determined from market data (e.g., one or more trader prices and/or quotes) on a second asset(s) in which the first and second assets may be fungible (and/or from market data on the first asset itself) (hereinafter referred to as “Category A” market data), from market data on a second asset(s) in which the second asset and an asset underlying the first asset may be fungible (and/or from market data on the underlying asset itself) (hereinafter referred to as “Category B” market data), from market data on a second asset(s) in which the first and second assets may be related (hereinafter referred to as “Category C” market data), or from market data on a second asset(s) applied to a financial model (and/or from market data on the first asset itself and/or an underlying asset) (hereinafter referred to as “Category D” market data). According to an embodiment of the invention, the first criteria applied to the market data may affect a resulting classification for a determined price such that “Category A” market data may cause a higher classification than “Category B” market data, “Category B” market data may cause a higher classification than “Category C” market data, and “Category C” may cause a higher classification than “Category D” market data, in which a higher classification may indicate that the determined price is more reflective of a market value of the first asset, for example, as compared to a lower classification (i.e., “Category A” market data may be of a higher quality than Category B” market data, “Category B” market data may be of a higher quality than Category C” market data, and “Category C” market data may be of a higher quality than Category D” market data).

According to an embodiment of the invention, a second criteria for determining a classification for a price of a first asset may include a type of the market data. For example, as described above, a price for a first asset may be determined from market data (whether Category A, Category B, Category C, and/or Category D) that includes one or more trade prices and/or one or more quotes for a second asset(s). According to an embodiment of the invention, a trade price for a second asset may be considered more reflective of a market value, for example, of the second asset as compared to a quote for the second asset. Similarly, according to an embodiment of the invention, market data that includes one or more trade prices, as compared to one or more quotes, for a second asset(s) may be considered to provide a price of the first asset that is more reflective of a market value of the first asset. As such, according to an embodiment of the invention, the second criteria applied to the market data may affect a resulting classification for the determined price of a first asset such that market data that includes one or more trade prices may cause a higher classification than market data that includes one or more quotes (i.e., market data that includes one or more trade prices may be of a higher quality than market data that includes one or more quotes).

According to an embodiment of the invention, a third criteria for determining a classification for a price of a first asset may include an age of the market data. For example, as described above, the price of a first asset may be determined from market data that includes one or more trade prices and/or one or more quotes for a second asset(s). In general, market data ages. According to an embodiment of the invention, a trade price and/or a quote for a second asset may be considered less reflective of a market value of the second asset as the trade price and/or quote ages. Similarly, according to an embodiment of the invention, when determining a price for a first asset using market data corresponding to a second asset(s), as the market data ages the data may be considered to provide a price for the first asset that is less reflective of a market value of the first asset. As such, according to an embodiment of the invention, the third criteria applied to the market data may affect a resulting classification for the determined price of a first asset such that less recent market data may cause a lower classification (i.e., more recent market data may be of a higher quality than less recent market data).

According to another embodiment of the invention, when the market data includes one or more quotes, a fourth criteria for determining a classification for a price of a first asset may include whether the one or more quotes include real quotes or include indicative quotes. For example, the price of a first asset may be determined from market data that includes one or more quotes for a second asset(s), which quotes may include real quotes and/or may include indicative quotes. According to an embodiment of the invention, a real quote for a second asset may be considered more reflective of a market value of the second asset as compared to an indicate quote for the second asset. Similarly, according to an embodiment of the invention, determining a price for a first asset using market data that includes one or more real quotes for a second asset(s) may be considered to provide a price for the first asset that is more reflective of a market value of the first asset as compared to market data that includes one or more indicative quotes for the second asset(s). As such, according to an embodiment of the invention, the fourth criteria applied to the market data may affect a resulting classification for the determined price of a first asset such that market data that includes one or more real quotes for a second asset(s) may cause a higher classification than market data that includes one or more indicative quotes for a second asset(s) (i.e., market data that includes one or more real quotes may be of a higher quality than market data that includes one or more indicative quotes).

According to another embodiment of the invention, when the market data includes one or more quotes, a fifth criteria for determining a classification for a price of a first asset may include whether the one or more quotes include live quotes or include cancelled quotes. For example, the price of a first asset may be determined from market data that includes one or more quotes for a second asset(s), which quotes may include live quotes and/or may include cancelled quotes. According to an embodiment of the invention, a live quote for a second asset may be considered more reflective of a market value of the second asset as compared to a cancelled quote for the second asset. Similarly, according to an embodiment of the invention, determining a price for a first asset using market data that includes one or more lives quotes for a second asset(s) may be considered to provide a price for the first asset that is more reflective of a market value of the first asset as compared to market data that includes one or more cancelled quotes for the second asset(s). As such, according to an embodiment of the invention, the fifth criteria applied to the market data may affect a resulting classification for the determined price of a first asset such that market data that includes one or more live quotes for a second asset(s) may cause a higher classification than market data that includes one or more cancelled quotes for a second asset(s) (i.e., market data that includes one or more live quotes may be of a higher quality than market data that includes one or more cancelled quotes).

According to another embodiment of the invention, a sixth criteria for determining a classification for a price of a first asset may include market liquidity. For example, the price of a first asset may be determined from market data on a second asset(s). According to an embodiment of the invention, a higher the liquidity of a second asset with respect to a market from which the market data originated, for example, the market data may be considered increasingly more reflective of a market value of the second asset. Similarly, according to an embodiment of the invention, determining a price for a first asset using market data corresponding to a second asset(s), a higher the liquidity of the second asset, the market data may be considered to provide a price for the first asset that is increasingly more reflective of a market value of the first asset. As such, according to an embodiment of the invention, the sixth criteria applied to the market data for a second asset(s) may affect a resulting classification for the determined price of a first asset such that a higher liquidity of the second asset(s) may cause a higher classification for the determined price (i.e., a higher the liquidity, the market data may be considered a higher quality).

According to another embodiment of the invention, when the market data includes one or more quotes, a seventh criteria for determining a classification for a price of a first asset may include the number of identically priced quotes (or alternatively, the number of substantially identically priced quotes, such as the number of quotes within a certain delta or range). For example, assuming the market data includes a bid price (or similarly an ask price and/or a bid and ask price) for a second asset, the larger the number of quotes for the second asset in a given market(s), for example, that have a same (or substantially the same) price as the bid price (e.g., increasing redundancy), the bid price may be considered increasingly more reflective of a market value of the second asset. Similarly, according to an embodiment of the invention, when determining a price for a first asset using market data that includes one or more quotes for a second asset(s), as the number of similarly or identically priced quotes increases, the market data may be considered to provide a price for the first asset that is increasingly more reflective of a market value of the first asset. As such, according to an embodiment of the invention, the seventh criteria applied to market data that includes one or more quotes of a second asset(s) may affect a resulting classification for the determined price of a first asset such that an increasing redundancy of the one or more quotes may cause a higher classification for the determined price (i.e., with an increasing redundancy of the one or more quotes the market data may be considered a higher quality).

According to another embodiment of the invention, an eighth criteria for determining a classification for a price of a first asset may include market depth. In particular, according to an embodiment of the invention, when the market data includes one or more trade prices and/or one or more quotes for a second asset, as a market depth for the second asset increases (e.g., the deeper the market(s) from which the market data originated), the market data may be considered increasingly more reflective of a market value of the second asset. Similarly, according to an embodiment of the invention, when determining a price for a first asset using market data for a second asset(s), a deeper the market(s) for the second asset(s), the market data may be considered to provide a price for the first asset that is increasingly more reflective of a market value of the first asset. As such, according to an embodiment of the invention, the eighth criteria applied to market data of a second asset(s) may affect a resulting classification for the determined price of a first asset such that increasing market depth of the second asset(s) may cause a higher classification for the determined price (i.e., with an increasing market depth the market data may be considered a higher quality).

According to another embodiment of the invention, when the market data includes one or more quotes, a ninth criteria for determining a classification for a price of a first asset may include volatility. For example, according to an embodiment of the invention, a lower a volatility of a second asset, market data (trade prices and/or quotes) for the second asset may be considered increasingly more reflective of a market value of the second asset. Similarly, according to an embodiment of the invention, determining a price for a first asset using market data corresponding to a second asset(s), a lower the volatility of the second asset(s) the market data may be considered to provide a price for the first asset that is increasingly more reflective of a market value of the first asset. As such, according to an embodiment of the invention, the ninth criteria applied to the market data for a second asset(s) may affect a resulting classification for the determined price of a first asset such that a lower the volatility of the second asset(s) may cause a higher classification for the determined price (i.e., a lower the volatility, the market data may be considered a higher quality).

According to another embodiment of the invention, a tenth criteria for determining a classification for a price of a first asset may include bid-ask spread. In particular, according to an embodiment of the invention, when the market data includes one or more quotes, including one or more bid and ask prices, for a second asset, as the spread between the bid and ask prices decreases (e.g., the spread between a best bid and best ask price), the market data may be considered increasingly more reflective of a market value of the second asset. Similarly, according to an embodiment of the invention, when determining a price for a first asset using market data that includes one or more bid and ask prices for a second asset(s), as the spread between the bid and ask prices decreases, the market data may be considered to provide a price for the first asset that is increasingly more reflective of a market value of the first asset. As such, according to an embodiment of the invention, the tenth criteria applied to market data that includes one or more bid and ask prices for a second asset(s) may affect a resulting classification for the determined price of a first asset such that a decreasing bid-ask spread may cause a higher classification for the determined price (i.e., with a decreasing bid-ask spread the market data may be considered a higher quality).

According to another embodiment of the invention, an eleventh criteria for determining a classification for a price of a first asset may include a quantity and/or size (hereinafter collectively referred to as quantity) of a second asset(s) as represented by the market data as compared to a quantity of the first asset, for example. In particular, according to an embodiment of the invention, the first asset may include a quantity, such as a quantity of stock. Similarly, market data for a second asset may include one or more trade prices and/or one or more quotes (e.g., one or more bid prices and/or ask prices) in which a trade price may be for a specified quantity of the second asset and in which a quote may be for a specified quantity of the second asset. According to an embodiment of the invention, with an increasing delta difference between the quantity of the first asset and the quantity of the second asset(s) as indicated by one or more trade prices and/or one or more quotes for the second asset(s), the market data may be considered to provide a price for the first asset that is increasingly less reflective of a market value of the first asset. For example, a trade price for a specified quantity of a second asset may not reflect a market value for the first asset when the first asset includes a quantity larger than the specified quantity of the second asset. As such, according to an embodiment of the invention, the eleventh criteria applied to market data for a second asset(s) may affect a resulting classification for the determined price of a first asset such that an increasing delta difference between a quantity of the first asset and a quantity of the second asset(s) as indicated by the market data may cause a lower classification for the determined price (i.e., with an increasing delta difference, the market data may be considered a lower quality). One skilled in the art will recognize that a similar criteria may apply with respect to a quantity of a second asset(s) as indicated by the market data as compared to a quantity of an underlying asset to the first asset.

According to another embodiment of the invention, a twelfth criteria for determining a classification for a price of a first asset may include a source of the market data. For example, according to an embodiment of the invention, the market data on a second asset(s) may include one or more trade prices and/or one or more quotes, in which the market data may come from the same or multiple sources. As described above, a source of market data may include, for example, one or more markets, such as a primary exchange, one or more secondary exchanges, one or more over-the-counter markets, one or more ECNs, etc. In general, the source of market data for a second asset may affect the degree to which the market data reflects a market value for the second asset. As such, according to an embodiment of the invention, the source of the market data may also affect the degree to which a price for the first asset determined from the market data may reflect a market value of the first asset.

For example, a second asset may be transacted on multiple markets, with market data from one market being more reflective of a market value of the second asset as compared to market data from a second market. For example, if the second asset is transacted on a primary exchange and also on an over-the-counter market, market data from the primary exchange may be more reflective of a market value of the second asset as compared to market data from the over-the-counter market. This may be because the primary exchange is a more liquid market for the asset as compared to the over-the-counter market, for example, or may be because the over-the-counter market includes transaction costs (e.g., an added dealer spread to the price) not encountered on the primary exchange, etc. One skilled in the art will recognize that market data for an asset from various markets may differ for other reasons. As such, according to an embodiment of the invention, the twelfth criteria applied to the market data may affect a resulting classification for the determined price of a first asset based on a source of the market data for the second asset(s) (i.e., different sources of market data may provide different qualities of market data).

According to another embodiment of the invention, a thirteenth criteria for determining a classification for a price of a first asset may include a source of the market data as compared to a market on which the first asset may be purchased and/or sold. For example, according to an embodiment of the invention, the market data on a second asset(s) may include one or more trade prices and/or one or more quotes from a first market. However, a trade price and/or quote from this first market may not be a valid trade price and/or quote on a second market and as such, the trade price and/or quote may not be reflective of a market value of the second asset with respect to the second market. For example, if a second asset is purchased on a primary exchange at a first price, it may not be possible to thereafter sell the asset on an over-the-counter market for the same price. As indicated above, one skilled in the art will recognize that trade prices and quotes between markets may differ for various reasons. Similarly, according to an embodiment of the invention, if a first asset is intended to be purchased and/or sold on a second market that differs from a first market from which the market data came, a price determined from this market data for the first asset may not be reflective of a market value for the first asset. As such, according to an embodiment of the invention, the thirteenth criteria applied to the market data may affect a resulting classification for the determined price of a first asset based on a source of the market data as compared to a market on which the first asset may be purchased and/or sold.

Again, one skilled in the art will recognize that other criteria in addition to those described above may be defined.

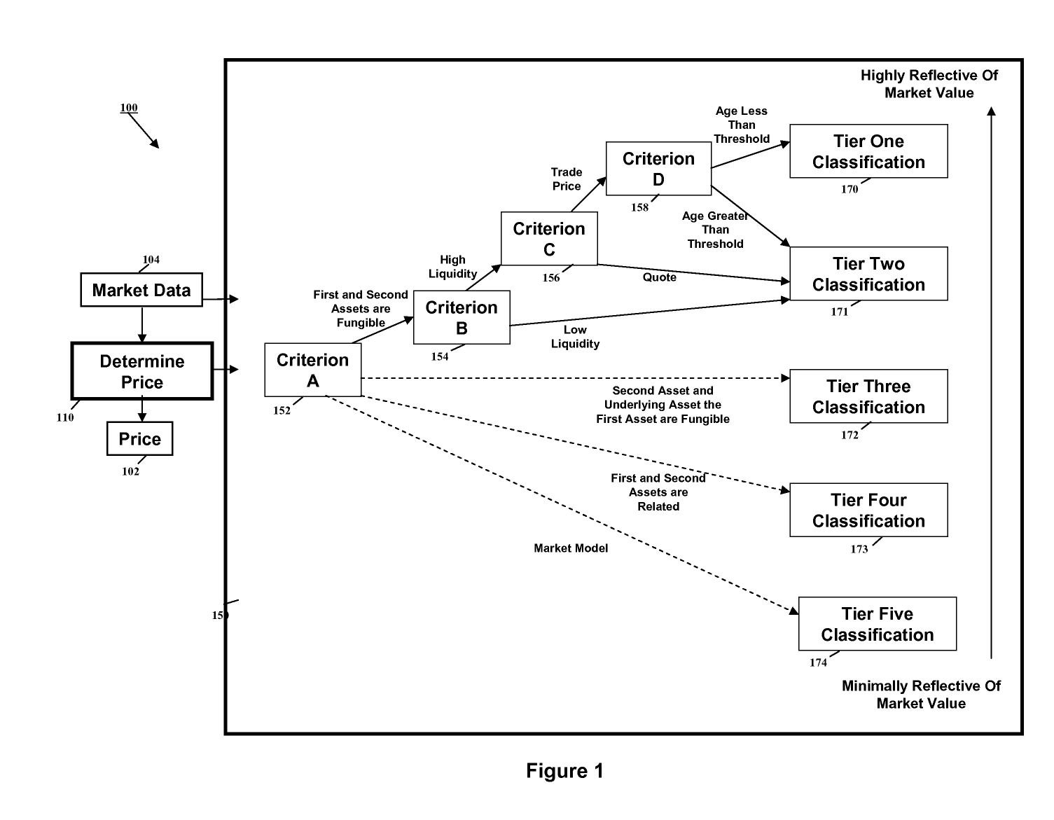

Referring now to FIG. 1, there is shown an example process 100 for determining a price of a first asset and a classification for the price according to an embodiment of the invention. Beginning with step 110, a price 102 may be initially determined for the first asset using market data 104 for one or more second assets, for example, in any of the above described fashions, for example. Again, one skilled in the art will recognize that the market data may also/alternatively be on the first asset itself and/or on an asset underlying the first asset.

Thereafter, at step 150 a classification may be determined for the price based on the market data 104, for example. In the example of FIG. 1, the determined classification may be one of five classifications making up a classification system including a “Tier One Classification” (170), a “Tier Two Classification” (171), a “Tier Three Classification” (172), a “Tier Four Classification” (173), and a “Tier Five Classification” (174). The five classifications 170-174 may have a ranked order. For example, according to an embodiment of the invention, a “Tier One Classification” may indicate that the determine price is highly reflective of a market value for the first asset while a “Tier Five Classification” may indicate that the determine price is minimally reflective of a market value for the first asset. As another example, a “Tier One Classification” may indicate that the determined price is a real or tradable price (e.g., a price at which a entity is committed to purchase and/or sell the asset) while a “Tier Five Classification” may indicate that the determine price is an indicative price (e.g., a price estimate from which further negotiations may be made).

According to an embodiment of the invention, step 150 for determining a classification may include, for example, using a plurality of criteria including “Criteria A” (152), “Criteria B” (154), “Criteria C” (156), and “Criteria D” (158) arranged in a tree-like fashion, for example, to analyze the market data 104. For example, beginning with Criteria A, which may be similar to the “first criteria” described above, a relationship of the market data to the first asset may be analyzed. Accordingly, based on Criteria A, if the price of the first asset was determined from market data on a second asset(s), for example, applied to a model, the price may be categorized as a Tier Five Classification (174) (alternatively, one or more additional criteria may be analyzed as represented by the dotted line). Alternatively, if the price of the first asset was determined from market data on a second asset(s) in which the first and second assets may be related, the price may be classified as a Tier Four Classification (173). Alternatively, if the price of the first asset was determined from market data on a second asset(s) in which the second asset and an asset(s) underlying the first asset may be fungible, the price may be classified as a Tier Three Classification (172). Alternatively, if the price of the first asset was determined from market data on a second asset(s) in which the first and second assets may be fungible, Criteria B (154) may be then used to analyze the market data.

Criteria B, which may be similar to the “sixth criteria” described above, may include an indication of market liquidity of the second asset(s). Accordingly, based on Criteria B, if the second asset has low liquidity as described above, the price may be categorized as a Tier Two Classification (171). Alternatively, if the second asset has high liquidity, Criteria C (156) may be then used to analyze the market data.

Criteria C, which may be similar to the “second criteria” described above, may include a type of the market data (e.g., whether the market data includes one or more trade prices and/or one or more quotes for a second asset(s)). Accordingly, based on Criteria C, if the market data includes one or more quotes, the price may be categorized as a Tier Two Classification (171). Alternatively, if the market data includes one or more trade prices, Criteria D (158) may be then used to analyze the market data.

Criteria D, which may be similar to the “third criteria” described above, may include an age of the market data. Accordingly, based on Criteria D, if the market data is equal to or older than a predefined threshold, for example, such as “W” days the price may be categorized as a Tier Two Classification (171). Alternatively, if the market data is younger than the predefined threshold, the price may be categorized as a Tier One Classification (170).

According to another embodiment of the invention, in addition to determining a classification for a price of an asset, the classification may include qualifying information. For example, as described above, an asset for which a price is determined may include a quantity. Accordingly, a classification may include a qualification that the classification is valid up to a specified quantity of the asset, for example. As another example, a classification may include a qualification that the classification is valid for a specified time period. As a further example, a classification may include a qualification that the classification is valid with respect to a specified market(s). One skilled in the art will recognize that other qualifying information may be possible.

According to another embodiment of the invention, a determined price may a current price, such as a price relative to the present day and as such, a classification for the price may be relative to the present day. According to another embodiment of the invention, a price may be a historic price, such as a price relative to any given day of any given year. According to an embodiment of the invention, a classification may be determined for the price relative to the given day and year. For example, the classification may provide an indication of how reflective the determined price was of a market value for the asset with respect to the given day and year. According to an embodiment of the invention, historic market data may be used to determine a historic price and/or corresponding classification.

According to another embodiment of the invention, in addition to determining a classification for a price, the classification may also be expressed as to which criteria may have been met to obtain the classification and/or expressed as having met all or a subset of criteria (e.g., the price meets “Y” of the “X” criteria). According to another embodiment of the invention, a classification may simply be expressed as to which of a subset of criteria the price may have met and/or expressed as the price having met all or a subset of criteria (e.g., the price meets “Y” of the “X” criteria). As an example, the more criteria a price meets may indicate that the price is more reflective of a market value of the asset. With respect to a criteria being met, as an example, the “first criteria” as described above may be considered met if the price of a first asset was determined from market data on a second asset in which the first and second assets may be fungible or if the price of a first asset was determined from market data on a second asset in which the second asset and an asset underlying the first asset may be fungible. As another example, the “second criteria” as described above may be considered met if the market data includes one or more trade prices (as compared to one or more quotes). As a further example, the “third criteria” as described above may be considered met if the market data is younger than the predefined threshold.

According to another embodiment of the invention, a price may be qualified using the criteria itself. For example, according to an embodiment of the invention, a plurality of criteria may be defined (e.g., “X” criteria) and a classification for a price expressed as one or more of any applicable criteria. For example, with respect to the “first criteria,” the “second criteria,” and the “third criteria” as described above, a price for a first asset may be expressed as having been determined from market data in which i) the market is on a second asset wherein the first and second assets are fungible, ii) the market data includes one or more trade prices, and iii) the market data is of “Z” age.

One skilled in the art will recognize that a classification for a determined price may be expressed in other ways. One skilled in the art will also recognize that any combination of the above described ways for expressing a classification may be used.

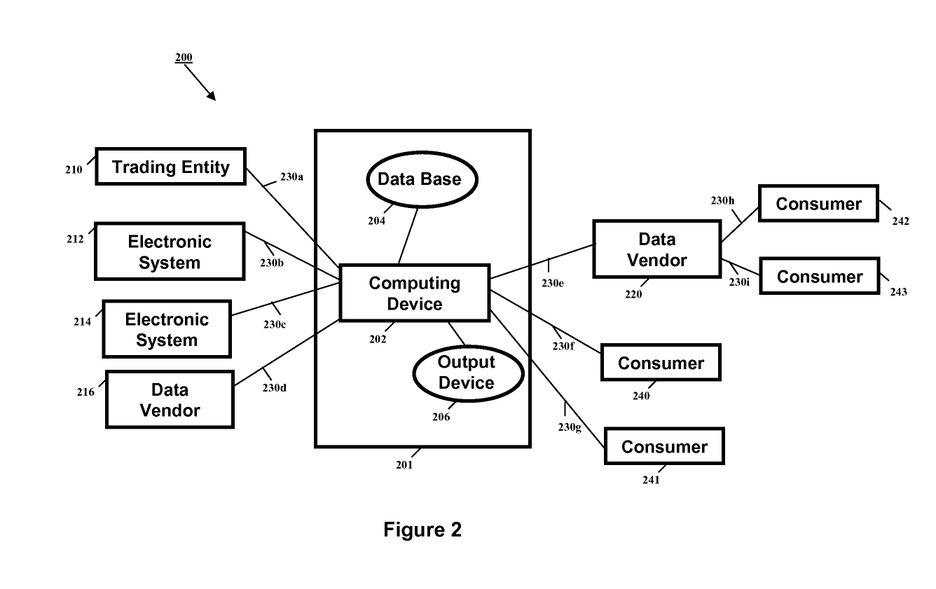

Referring now to FIG. 2, there is shown a system 200 according to an embodiment of the invention. System 200 may include an entity 201 directed at determining for any one or more of a plurality of assets a price of a given asset and a classification for the price. In particular, according to an embodiment of the invention, one or more individuals associated with entity 201 may determine for any one or more of a plurality of assets a price of a given asset and a classification for the price. According to another embodiment of the invention, entity 201 may include at least one computing device 202 (e.g., a server computer) operable to determine for any one or more of a plurality of assets a price of a given asset and a classification for the price. According to another embodiment of the invention, a combination of one or more individuals and computing device 202 may determine for any one or more of a plurality of assets a price of a given asset and a classification for the price. For description purposes, entity 201 will be described from the perspective of computing device 202. Nonetheless, one skilled in the art will recognize that one or more operations, or portions thereof, described below may be performed by one or more individuals. One skilled in the art will also recognize that one or more operations, or portions thereof, described below may be performed by one or more other entities (including individuals and/or computing devices associated therewith) of system 200 including one or more sources 210-216 of market data, one or more data vendors 220, and/or one or more consumers 240-243.

Computing device 202 may include at least one processor, a memory, such as ROM, RAM, FLASH, etc., and a computer readable medium type memory, such as a hard drive, a flash-drive, an optical or magnetic disk, etc. The memory and/or computer readable medium may include software stored thereon that when executed on a processor, may determine a price of an asset and a classification for the price.

According to an embodiment of the invention and as described herein, computing device 202 may determine a price of an asset and a classification for the price based on market data (e.g., one or more trade prices and/or one or more quotes) from one or more sources including, for example, one or more markets, such as one or more primary exchanges, one or more secondary exchanges, one or more over-the-counter markets, and/or one or more ECNs, etc. Again, other markets are possible. As shown in FIG. 2, system 200 may include one or more sources 210-216 that may provide to computing device 202 market data from any one or more markets. For example, computing device 202 may receive market data from one or more trading entities (e.g., brokers, dealers, investors) 210 associated with one or more markets, may receive market data from one or more electronic systems 212 that post trade prices and/or quotes associated with one or more markets, and/or may receive market data from one or more electronic systems 214 that conduct and/or assist in electronic trading associated with one or more markets. Computing device 202 may also receive market data from one or more data vendors 216 that may obtain market data from one or more markets. One skilled in the art will recognize that other sources of market data are possible.

According to another embodiment of the invention, computing device 202 may be an electronic system and/or part of and/or associated with an electronic system that posts trade prices and/or quotes associated with one or more markets. According to an embodiment of the invention, such an electronic system may be associated with entity 201. Alternatively or in addition, computing device 202 may be an electronic system and/or part of and/or associated with an electronic system for conducting and/or assisting in electronic trading associated with one or more markets. Again, such an electronic system may be associated with entity 201. According to another embodiment of the invention, entity 201 and/or computing device 202 may be a trading entity (e.g., broker, dealer, investor). Accordingly, computing device 202 and/or entity 201 may itself be a source of market data for computing device 202.

As further shown in FIG. 2, system 200 may also include one or more communications networks 230a-230d through which computing device 202 may receive market data from sources 210-216. Communications networks 230a-230d may include one or more local area networks (LAN), wide area networks (WAN), the Internet, telephone networks (POTS), wireless networks (e.g., cellular, WiFi, and/or WiMax networks), and/or a combination thereof, for example.

According to an embodiment of the invention, computing device 202 may receive market data, including current market data (e.g., current trade prices and/or quotes) and/or historic market data (e.g., historic trade prices and/or quotes), from any of sources 210-216 in various fashions. For example, according to an embodiment of the invention, computing device 202 may continuously receive all available market data or a portion of the available market data from a given source 210-216. In particular, computing device 202 may continuously receive the market data from a given source 210-216 in real time. For example, computing device 202 may receive the market data as the data is made available by a given source 210-216 and/or as the data changes, for example. Alternatively and/or in addition, computing device 202 may continuously receive the market data at periodic reporting periods. The data reported at each reporting period may include, for example, the current market data at the time of reporting, changes in the market data since the last reporting period, all market data that transpired since the last reporting period, etc. One skilled in the art will recognize that computing device 202 may continuously receive market data in other fashions.

One receiving the market data, computing device 202 may then filter the market data to obtain the necessary information to determine a price of an asset and classification for the price and/or may store all or a portion of the data in one or more databases 204 associated with computing device 202 and/or to which computing device 202 may have access.

According to another embodiment of the invention, computing device 202 may continuously receive market data from a given source 210-216 as described above. However, the market data may be prefiltered, for example, at a given source such that only a requested set of data is received by the computing device.

According to another embodiment of the invention, rather than continuously receiving market data from a given source 210-216 as described above, computing device 202 may request market data from a given source 210-216 as needed. According to an embodiment of the invention, computing device 202 may request all or a portion of the current market data available at the time of the request, may request specific current market data available at the time of the request, may request the past “W” seconds, minutes, or hours, for example, of market data, etc. One skilled in the art will recognize that computing device 202 may request market data in other fashions.

According to another embodiment of the invention, computing device 202 may receive historic market data from a given source 210-216, which market data may be requested as needed. Alternatively or in addition, computing device 202 may retrieve historic market data from one or more databases 204, for example.

According to an embodiment of the invention, once determining a price of an asset and a classification for a price, computing device 202 may make the price and classification available. For example, according to an embodiment of the invention, computing device 202 may include and/or be connected to one or more output devices 206 through which computing device 202 may make a price and classification available. Example output devices may include a display monitor (e.g. a cathode ray tube or liquid crystal display), an audio output (e.g., a speaker), a printer, etc.

According to another embodiment of the invention, computing device 202 (and/or another computing device(s) and/or individual(s) associated with entity 201) may make a price of an asset and classification of the price available to one or more consumers 240-243. One skilled in the art will recognize that a consumer may be any entity including, for example, a business and/or individual associated therewith, a private individual, etc. One skilled in the art will also recognize that a consumer may or may not pay to obtain a price of an asset and/or a classification of the price.

In particular, according to an embodiment of the invention a price and a classification may be provided to a given consumer 241 in a paper form, such as part of a report.

According to another embodiment of the invention, computing device 202 may make a price and classification available to a given consumer 240/241 over a communications network 230f/230g (which may be similar to networks 230a-230d). For example, a price and classification may be made available to a consumer 240/241 verbally, such as through a phone.

Alternatively, any given consumer 240/241 may have a mobile/cellular phone, a facsimile machine, a network printer, a PDA (personal digital assistant), a pocket PC (personal computer), a personal computing device (e.g., a laptop), a pager, or any special or general purpose computing device to which computing device 202 may send a price and classification, including as an email, an instant message, etc.

As another example, computing device 202 may be a server from which a consumer 240/241 may retrieve a price and classification via communications network 230f.

According to an embodiment of the invention, computing device 202 (and/or another computing device(s) associated with entity 201) may be a web server that hosts a web site. Accordingly, a consumer 240/241 may have a computing device, as described above, with an associated web browser through which consumer 240/241 may obtain a price and classification from computing device 202 and/or through which computing device 202 may cause a price and classification to be displayed.

According to another embodiment of the invention, computing device 202 may be associated with one or more data vendors 220. A data vendor 220 may include, for example, one or more computing devices and/or individuals. According to an embodiment of the invention, computing device 202 (and/or another computing device(s) and/or individual(s) associated with entity 201) may make a price and classification available to a data vendor 220 over a communications network 230e (which be similar to networks 230a-230d), although one skilled in the art will recognize that a price and classification may be made available to a data vendor 220 in other ways. Thereafter, a data vendor 220 may make the price and classification available to one or more consumers 242/243, as similarly described above for consumers 240 and 241. For example, a data vendor 220 may make a price and classification available to a consumer 242/243 in a paper form. As another example, data vendor 220 may make a price and classification available to a consumer 242/243 over a communications network 230h/230i (which be similar to networks 230a-230d), such as verbally and/or via a computing device associated with a consumer 242/243, as similarly described above. As a further example, a consumer 242/243 may retrieve a price and classification from a data vendor 220.

According to an embodiment of the invention, data vendor 220 may include a web server that hosts a web site. As similarly described above, a consumer 242/243 may have a computing device and an associated web browser through which the consumer may obtain a price and classification from the web server and/or through which the web server may cause a price and classification to be displayed.

According to an embodiment of the invention, computing device 202 may determine a price of an asset and a classification for the price in response to a request received from a requester (e.g., a consumer 240-243, and/or a data vendor 220, and/or a data vendor 220 on behalf of a consumer 242/243). For example, a consumer 240-243 may make a request to computing device 202 (and/or another computing device(s) and/or individual(s) associated with entity 201) via phone, mail, email, instant message, a web site provided by computing device 202, and/or via a data vendor 220, etc. In general, a requester may request a current price and classification and/or or a historic price and classification. To determine the price and classification, computing device 202 may use market data obtained, for example, in any of the above described fashions from one or more of sources 210-216. For example, computing device 202 may use the most current market data available at the time of the request. Thereafter, computing device 202 may make the determined price and classification available to the requester in any of the above described fashions.

According to another embodiment of the invention, computing device 202 may automatically determine a price of a given asset and a classification for a price. For example, computing device 202 may continuously determine and/or update a price of an asset and a classification for the price using market data obtained, for example, in any of the above described fashions from one or more of sources 210-216. As another example, computing device 202 may, on a periodic basis (e.g., every “W” seconds, every hour, once at end of day), determine and/or update a price of an asset and a classification for the price. As a further example, computing device 202 may determine and/or update a price of an asset and a classification for the price as market data is received from one or more of sources 210-216, for example, and/or as such market data may cause the price and/or classification to change. In general, computing device 202 may use the most current market data available from one or more of sources 210-216, for example, at the time of each update. Thereafter, in response to a request from a requester, computing device 202 may make any of the automatically determined prices for an asset and classifications for the prices, including for example the most recently determined price and classification, available to the requester in any of the above described fashions. Alternatively, rather than make an automatically determined price and classification available upon request, computing device 202 (and/or another computing device(s) associated with entity 201) may automatically make a price of an asset and a classification for the price available. For example, computing device 202 may continuously make a price and classification available to a consumer 240/241 via a web site or instant messaging or email, for example, continuously updating the price and classification each time the price and/or classification is determined and/or on a periodic basis, as similarly described above. As another example, computing device 202 may continuously make the price and classification available to a data vendor 220 and/or a consumer 242/243 via a data vendor 220, continuously updating the data vendor with the updated price and classification each time the price and/or classification is determined and/or on a periodic basis. One skilled in the art will recognize that computing device 202 may make a price and classification available in other fashions.

According to another embodiment of the invention, in addition to determining and making available a price and classification for any given asset as described above, entity 201 or in particular computing device 202, for example, may also determine and make available prices for a plurality of assets and a classification for each determined price, as similarly described above. For example, according to an embodiment of the invention, computing device 202 in response to a request may determine for each of a plurality of assets a respective price and a classification for each price and then make the prices and classifications available. According to another embodiment of the invention, computing device 202 may automatically determine and/or update for each of a plurality of assets a respective price and a classification for each price as similarly described above, and then make the prices and classifications available as requested and/or automatically, as similarly described above. For example, according to an embodiment of the invention, computing device 202 (and/or another computing device(s) associated with entity 201) may host a web site through which the computing device may continuously make available and update in an automatic fashion a price for each of a plurality of assets and a classification for each price.

According to another embodiment of the invention, entity 201 or in particular computing device 202, for example, may determine for a given asset at any given time any of a plurality of different prices and a classification for each determined price such that the classification for any two or more of the prices may differ. Specifically, according to an embodiment of the invention, at any given time computing device 202 may have varying sets of market data (e.g., one or more trade prices and/or one or more quotes) of varying qualities from which a price for a given asset may be determined (note that the varying sets of market data may be from a same or varying times). In general, higher quality market data may result in a determined price with a higher classification (e.g., a price that is more indicative of a market value of an asset) as compared to lower quality market data, as described above. As a result, at any given time computing device 202 may determine for a given asset any one or more of a plurality of prices in which each price may have a different classification. For example, computing device 202 may receive a first set of market data from a first source and a second set of market data from a second source in which the first set of market data may be of a higher quality than the second set, resulting in a first price determined from the first set of market data having a higher classification than a second price determined from the second set of market data. As another example, computing device 202 may receive from a given source both a first and a second set of market data of varying qualities such that a first price determined from the first set of market data may have a higher classification than a second price determined from the second set of market data.

One skilled in the art will recognize that different sets of market data from which prices of given asset may be determined may be of varying qualities for different reasons, as described above. For example, a first set of market data may be more timely than a second set of market data, a first set of market data may include trade prices while a second set of market data may include only quotes, a first set of market data may be from a more liquid market as compared to a second set of market data, a first set of market data may include real quotes while a second set of market data may only include indicative quotes, etc.

According to an embodiment of the invention, with respect to a given asset a given source 210-216, for example, may provide market data of varying qualities. According to another embodiment of the invention, with respect to a given asset one or more different sources 210-216, for example, may provide market data of varying qualities.

According to an embodiment of the invention, computing device 202 may receive from a requester a request for a price of an asset, including a current price and/or or a historic price, as similarly described above. Thereafter, computing device 202 may determine a price for the asset and a classification for the price using, for example, any quality market data available at the time of the request and in accordance with the request, such as the highest quality market data available, and then make the price and classification available to the requester, as similarly described above. According to another embodiment of the invention, computing device 202 may receive a request for a price of an asset, which request may include an indication that the price should meet a specified classification, or possibly meet and/or exceed a specified classification. Thereafter, computing device 202 may use an appropriate quality of market data to determine a price such that the price meets and/or exceeds the specified classification, and then make the price and possibly the classification available, as similarly described above. According to another embodiment of the invention, computing device 202 may receive a request for a price of an asset, which request may include an indication that the price should fall within a specified range of classifications. One skilled in the art will recognize that other types of requests may be made.

According to another embodiment of the invention, computing device 202 may use varying sets of market data of varying qualities to automatically determine and/or update for a given asset a plurality of prices at different classifications. The automatic determining/updating of prices for an asset may occur as similarly described above. Thereafter, computing device 202 may make one or more of the determined prices and classifications available in various fashions, as similarly described above. For example, in response to a request from a requester, computing device 202 may make one or more of the automatically determined prices at any of the varying qualities available to the requester in any of the above described fashions. As another example, in response to a request for a price at a specified classification, computing device 202 may make the most recently determined price at the specified classification (or possibly a better classification) available. As a further example, computing device 202 may make one or more of the determined prices at the varying classifications automatically available, such as through a web site, continuously and/or periodically updating the plurality of prices at the different classifications, as similarly described above.

According to another embodiment of the invention, in addition to determining and making available a plurality of prices of varying classifications for a given asset, entity 201 and in particular computing device 202, for example, may also determine and make available a plurality of prices of varying classifications for a plurality of assets, as similarly described above.

According to another embodiment of the invention, entity 201, including for example one or more computing devices such as device 202 and/or one or more individuals, may determine and charge a fee for determining and/or providing a price of an asset. For example, according to an embodiment of the invention, computing device 202 may receive from a requester a request for a price of an asset, which request may also include an indication that the price should meet a specified classification, or range of classifications, etc. as described above. Thereafter, computing device 202 may make a determined price and possibly a classification for the price available to the requester, as similarly described above. In addition, computing device 202 may also determine and/or charge the requester a fee for providing the price. For example, according to an embodiment of the invention, computing device 202 may charge a flat fee or the same fee independent of regardless of the classification of the determined price. According to another embodiment of the invention, computing device 202 may determine a fee based on the classification of the determined price. For example, the fee may be directly tied to the classification such that the higher the classification of the determined price, the higher the fee. As another example, there may be no fee for a price that has classification up to a certain level, and a flat fee for a price that has a classification above the level. As another example, there may be no fee for a price that has a classification up to a certain level, and for any classification above the level, a fee that increases with the classification. As another example, there may be a first flat fee for a price that has any classification up to a certain level, and a second, possibly higher flat fee for a price that has any classification above the level. As another example, there may be a flat fee for a price that has any classification up to a certain level, and for any classification above the level a fee that increases with the classification. One skilled in the art will recognize that other fee structures are possible including any combination of the above described structures.

According to another embodiment of the invention, a requester may need to pay a subscription fee to entity 201, for example, in order to request a price of an asset and thereafter pay an additional fee as described above for each request. The subscription fee may vary with respect to a certain period of time/duration over which a requester may make requests (e.g., a yearly subscription), and/or for a number of requests a requester may make, and/or for which asset(s) a requester may request prices, etc. Alternatively and/or in addition the subscription fee may vary with respect to classification. For example, a first subscription fee may allow a requester to obtain prices up to and including a certain classification level and a second possibly higher fee may allow the requester to obtain prices above the certain classification level, etc. One skilled in the art will recognize that other subscription fee structures are possible.

According to another embodiment of the invention, rather than a requester paying a fee for each price request, a requester may only pay a subscription fee to entity 201, for example, as similarly described above.

One skilled in the art will recognize that when a requester is a data vendor 220, for example, that provides a determined price to a consumer 242/243, for example, the data vendor may pay one or more first fees to entity 201 as described above, for example, and may thereafter charge one or more second fees to the consumer 242/243, which second fees may be the same as and/or different from the first fees. For example, a data vendor 220 may resell and/or repackage the services provided by entity 201.

According to another embodiment of the invention, computing device 202 may automatically determine and/or update for a given asset and/or for each of a plurality of assets a plurality of prices at different classifications as described above, and may then automatically make one or more of the prices and classifications for one or more of the assets available for a fee. For example, as described above, computing device 202 may continuously and/or periodically determine/update a plurality of prices at different classifications for one or more assets and then continuously and/or periodically make the prices and classifications available to a consumer 240/241 (e.g., via a web site, instant messaging, email, etc.) and/or to a data vendor 220, which in turn may make the prices and classifications available to a consumers 242/243 in various fashions. According to an embodiment of the invention, computing device 202 (and/or another computing device(s) and/or individual(s) associated with entity 201) may determine and/or charge a consumer 240/241 and/or a consumer 242/243 (either directly or via a data vendor 220) and/or data vendors 220 various fee structures, such as a subscription fee, to obtain one or more prices and classifications of one or more assets in this fashion. In general, such a fee may vary with respect to a certain period of time/duration over which a consumer/data vendor may obtain prices and classifications (e.g., a yearly subscription), and/or for which asset(s) a consumer/data vendor may obtain prices and classifications, and/or the number of asset(s) for which a consumer/data vendor may obtain prices and classifications, etc. According to various embodiments of the invention, a consumer/data vendor may or may not be able to specify the assets for which prices and classifications may be obtained.

According to various embodiments of the invention, the fee paid by a consumer/data vendor to automatically obtain prices and classifications as described above may or may not also be related to the classification of the prices received. For example, according to another embodiment of the invention a consumer/data vendor may pay a flat fee (e.g., a fee independent of classification), which may allow the consumer/data vendor to obtain for a given asset(s) all available prices at all classifications. According to another embodiment of the invention, a fee paid by a consumer/data vendor may affect the prices and classifications that the consumer/data vendor may obtain. For example, a consumer/data vendor may need to pay an increasingly higher fee to obtain for a given asset(s) available prices at increasingly higher classifications. As another example, a consumer/data vendor may not need to pay any fee to obtain for a given asset(s) all available prices at all classifications up to a certain level, and may need to pay a flat fee to obtain for a given asset(s) all available prices at all classifications above the level. As another example, a consumer/data vendor may need to pay a first flat fee to obtain for a given asset(s) all available prices at all classifications up to a certain level, and may need to pay a second flat fee, possibly higher than the first fee, to obtain for a given asset(s) all available prices at all classifications above the level. As another example, a consumer/data vendor may need to pay a flat fee to obtain for a given asset(s) available prices at classifications up to a certain level, and may need to pay an increasingly higher fee to obtain for a given asset(s) all available prices at increasingly higher classifications above the level. One skilled in the art will recognize that other fee structures are possible including any combination of the above described structures.

One skilled in the art will recognize that when a data vendor 220, for example, pays one or more first fees to obtain one or more prices and classifications of one or more assets in an automatic fashion as described, the data vendor 220 may then resell and/or repackage the prices and classifications services to a consumer 242/243, for example, at a one or more second fees that may be the same as and/or different from the first fees.

In general, one skilled in the art will recognize that various factors may affect the fee entity 201 determines and/or charges to provide one or more prices at various classifications for one or more assets. For example, a source 210-216 may charge entity 201a fee for providing market data, which fee may be dependent upon the quality of the market data the source provides. Accordingly, entity 201 may charge a higher fee to provide a price of an asset with a higher classification as a result of having to use higher quality market data to determine such a price.

According to another embodiment of the invention, in addition to and/or alternatively to using various fee structures as described above to obtain access to various classifications of prices for an asset(s), entity 201 and in particular computing device 202, for example, and/or data vendor 220, for example, may also use one or more various access privileges (e.g., logins, passwords, security codes, authentication codes (e.g., based on one or more pieces of biometric data), etc.) to obtain access to various classifications of prices for an asset(s). For example, a consumer may require a single access privilege to obtain a price of an asset at any classification. As another example, no access privilege may be required to obtain a price that has classification up to a certain level, while an access privilege may be required for a price that has a classification above the level. As another example, a first access privilege may be required to obtain a price that has classification up to a certain level, while a second access privilege may be required for a price that has a classification above the level. One skilled in the art will recognize that other access privilege configurations may be used. One skilled in the art will also recognize that a single consumer, for example, may have more than one access privilege.

According to an embodiment of the invention, if biometric data is used as an access privilege, a computing device associated with a consumer 240-243 (and/or with computing device 202 and/or a data vendor 230) may include and/or be associated with at least one biometric sensor. The biometric sensor may be any device that may be used to determine directly from a consumer at least one item of biometric data associated with a consumer, such as a fingerprint reader, an iris scanner, a retinal scanner, a vascular pattern reader, a facial recognition camera, a voice recognition system, etc. The biometric sensor may be embodied in hardware, software, or a combination thereof. The biometric sensor may further share resources with other components of a consumer's computing device, such as a processor, memory, a camera, a microphone, a speaker, etc. A single biometric sensor may be used for reading more than one type of biometric data. For example, a digital camera may be used to obtain an image of an eye for iris scanning and an image of a face for facial recognition. In this instance, a single image capture of a face may provide data for facial recognition as well as data for iris or retinal comparisons. Again, the biometric data may generally be obtained and used at least to authenticate an identity of a consumer for providing access privilege to one or more various prices at various classifications. In this regard, biometric data may be compared with previously obtained/stored biometric data that has been verified as being associated with a particular consumer, which data may be stored on a consumer's computing device and/or at entity 210 and/or data vendor 220, for example.

According to one example embodiment of the invention with respect to access privileges, a consumer (such as consumer 240/241) using a computing device (which may be referred to as a controlled device) may make a request to computing device 202 for the controlled device to display to the individual one or more prices of an asset and a classification for each price. The consumer and/or controlled device may also send an access privilege (e.g., a code or password) to computing device 202. Thereafter, computing device 202 may determine for the asset a plurality of prices and a classification for each price. Computing device 202 may then compare the access privilege of the consumer with an information reference (e.g., a database), which reference may provide an indication as to which classification levels may be accessible to the consumer based on a given access privilege. Thereafter, computing device 202 may forward all determined prices to the controlled device and then control the device to only display to the consumer those prices that are accessible to the consumer as determined by the comparison of the access privilege with an information reference. In this aspect, computing device 202 may operate as an authorization control system controlling the controlled device with respect to the information displayed by the device to the consumer.

According to various embodiments of the invention, a price of an asset and a classification of a price may be used in various ways. For example, according to an embodiment of the invention, an entity 201, for example, may not only provide a price of an asset and a classification for the price, entity 210 may also provide, for example, a price of a portfolio of assets, or a price of a structured product (e.g., an investment instrument that may be a combination of at least one derivative and one or more other financial instruments), etc. and a classification of the price. In general, a portfolio or structured product, for example, may be specific to a given entity (e.g., a company may have a set of assets it wants to collectively value) and/or open to (e.g., investable by) any one or more entities. According to an embodiment of the invention, a price and corresponding classification for a portfolio or structured product, for example, may be determined by determining a price and corresponding classification for each asset that makes up the portfolio. The classifications of the various prices may be the same and/or differ. Thereafter, the prices and classifications may be combined into a single price and classification. For example, an average and/or weighted average may be used to combine the prices and classifications. Again, a fee may be determined and charged for determining a price/classification of a portfolio and/or a structured product

According to another embodiment of the invention, a price of an asset and a classification of a price may be used in connection with risk compliance. For example, an entity (e.g., an investor such as an individual(s), a company, etc.) may need to pledge or offer collateral (e.g., an asset) to support or secure repayment of an obligation, such as a loan or other credit. According to one embodiment of the invention, in addition to determining a price (e.g., a value) for an asset being used as collateral, a classification for the price may also be determined. Thereafter, the classification of the price may be used to determine the amount of the obligation secured by the asset or alternatively, the amount of an obligation that may be taken on by the entity. For example, a low classification of the determined price may indicate a low accuracy of the price as compared to a market value of the asset. As a result, a small portion of the determined price of the asset may be deemed to secure the obligation. Similarly, a high classification of the determined price may indicate a high accuracy of the price as compared to a market value of the asset. As a result, all or a large portion of the determined price of the asset may be deemed to secure the obligation. As such, according to an embodiment of the invention, once a price of an asset is determined, that price may adjusted based on a classification of the price and the adjusted price then used as the degree to which an asset may secures an obligation, or alternatively, the amount of an obligation that may be taken on by an entity.

According to another embodiment of the invention, when an asset is used as collateral to secure an obligation, an asset price (e.g., value) at a certain/required/specified classification may be needed in which the required classification may be based on the size of the obligation and/or the risk of the entity defaulting on the obligation. For example, when the size of an obligation and/or risk of default is small, the required classification for a determined price of an asset may be low in that an accuracy of the price may be less important whereas when the size of an obligation is large and/or risk of default is high, the required classification for a determined price of an asset may be high in that an accuracy of the price may be more important. According to a further embodiment of the invention, if the size of an obligation increases and/or the risk of an entity defaulting on the obligation increases, the required classification for a determined price of an asset may be increased, possibly resulting in a new price for the asset being determined such that the price meets or exceeds the new classification. In this way, a determination can be made as to whether the asset still adequately secures the obligation.

According to another embodiment of the invention, regulations may be enacted that require a price of an asset to meet certain classifications. For example, according to an embodiment of the invention, accounting standards/laws/regulations (hereinafter collectively referred to as standards), financial reporting standards, and/or compliance standards may require that when using and/or reporting a price/value of an asset, the price/value must have/meet a certain specified classification or better as set forth by the standards. According to another embodiment of the invention, accounting, financial reporting, and/or compliance standards, for example, may require that when using and/or reporting a price/value of an asset, a classification of the price/value must also be specified/provided/made available. For example, an entity reporting a price of an asset may indicate, for example, a classification of the price, and/or may indicate that the price meets X out of Y criteria required by the standards, and/or may indicate the criteria met and/or not met, etc. According to another embodiment of the invention, the classification may be used as a label. According to another embodiment of the invention, accounting, financial reporting, and compliance standards, for example, may require that when using and/or reporting a price/value of an asset, if a classification of the price/value is at or below a specified classification as set forth by the standards, the classification of the price must also be specified/provided/made available.

According to another embodiment of the invention, a rating and/or certification system may be established for rating and/or certifying a source, such as source 210-216, of market data. Specifically, as indicated above, market data may be of varying qualities with higher quality market data, for example, resulting in determined prices with a higher classification (e.g., a price that is more indicative of a market value of an asset) as compared to lower quality market data. As also indicated above, different sources of market data may provide different qualities of market data. According to an embodiment of the invention, a rating may be assigned to a source of market data in which the rating may be indicative of the quality of the market data the source provides. According to an embodiment of the invention, in addition to a quality of the market data provided by a source, the source may need to adhere to and/or establish one or more guidelines and/or practices to obtain and/or maintain a certain rating. According to an embodiment of the invention, a source of market data may need to under-go a process (possibly once or periodically) to obtain and/or maintain a rating. A source of market data may pay a fee to obtain and/or maintain a rating.

According to another embodiment of the invention, a source of market data may be given a certification that the source provides and/or exceeds a certain quality of market data. According to an embodiment of the invention, a source of market data may need to adhere to and/or establish one or more guidelines and/or practices to obtain a certification. According to an embodiment of the invention, a source of market data may need to under-go a certification process (possibly once or periodically) to obtain and/or maintain a certification. A source of market data may pay a fee to obtain and/or maintain a certification.

According to another embodiment of the invention, a rating and/or certification system may be established for rating and/or certifying an entity, such as entity 201, the determines/provides prices for assets and/or classifications for prices. According to an embodiment of the invention, a rating may be assigned to an entity in which the rating may be indicative of the quality of the prices the entity provides and/or the highest classification of prices the entity may provide. According to an embodiment of the invention, in addition to a quality of the prices an entity may provide, an entity may need to adhere to and/or establish one or more guidelines and/or practices to obtain and/or maintain a certain rating. According to an embodiment of the invention, an entity may need to under-go a process (possibly once or periodically) to obtain and/or maintain a rating. An entity may pay a fee to obtain and/or maintain a rating. According to another embodiment of the invention, an entity may be given a certification that the entity provides prices that meet and/or exceed a certain quality and/or classification. According to an embodiment of the invention, an entity may need to adhere to and/or establish one or more guidelines and/or practices to obtain a certification. According to an embodiment of the invention, an entity may need to under-go a certification process (possibly once or periodically) to obtain and/or maintain a certification. Again, an entity may pay a fee to obtain and/or maintain a certification.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An authorization control system to determine operation of a controlled device to permit an individual to perform an action, the system comprising:
a computing device operable:
to receive from the individual a request for the controlled device to display one or more prices for an asset;
to receive an access privilege of the individual from the controlled device;
to determine for the asset a plurality of prices;
to determine for each of the plurality of prices a classification from a plurality of classifications that have a ranked order;
to compare the access privilege with a reference to determine which of the plurality of classifications are accessible by the individual;
to forward to the controlled device the plurality of prices; and
to control the controlled device to only display to the individual those determined prices that are accessible by the individual as determined by the comparison of the access privilege with the reference.

2. A method comprising:
determining a price of an asset from market data;
applying one or more criteria to the market data; and
determining for the price a classification from a plurality of classifications based on the application of the one or more criteria to the market data.

3. The method of claim 2, in which the asset comprises a financial instrument.

4. The method of claim 2, in which the market data comprises at least one of:
a trade price,
a bid price, and
an ask price.

5. The method of claim 2, in which the plurality of classifications comprise a ranked order.

6. The method of claim 5, in which each of the plurality of classifications comprises an increasing indication of how reflective the determined price is of a market value of the asset.

7. The method of claim 5, in which each of the plurality of classifications comprises an increasing indication of an accuracy of the determined price to a market value of the asset.

8. The method of claim 5, in which each of the plurality of classifications comprises an increasing indication of whether the determined price comprises a firm price.

9. The method of claim 2, in which the determined classification comprises at least one of:
an indication of how reflective the determined price is of a market value of the asset,
an indication of an accuracy of the determined price to the market value of the asset, and
an indication of how firm the determined price is.

10. The method of claim 2, in which the plurality of classifications comprise at least one of:
a contiguous range of values, and
a discrete set of values.

11. The method of claim 2, in which the market data comprises data on the asset.

12. The method of claim 2, in which the asset comprises a first asset and in which the market data comprises data on at least one second asset.

13. The method of claim 12, in which at least one of:
the first asset and the second asset are fungible, and
the first asset and the second asset are related.

14. The method of claim 12, in which the first asset comprises at least one underlying asset and in which at least one of:
the second asset and the underlying asset are fungible, and
the second asset comprises the underlying asset.

15. The method of claim 2,
in which applying the one or more criteria to the market data includes determining a quality of the market data; and
in which determining the classification from the plurality of classifications comprises determining a higher classification based on a higher the quality of the market data.

16. The method of claim 15,
in which the plurality of classifications comprise a ranked order; and
in which the higher the determined classification from among the plurality of classifications comprises at least one of:
an increasing indication of how reflective the determined price is of a market value of the asset,
an increasing indication of an accuracy of the determined price to the market value of the asset, and
an increasing indication of whether the determined price comprises a firm price.

17. The method of claim 15, in which the one or more criteria comprise whether the market data comprises at least one of a trade price and a quote, and in which the trade price comprises a higher quality than the quote.

18. The method of claim 15, in which the one or more criteria comprise an age of the market data, and in which more recent market data comprises a higher quality.

19. An apparatus comprising a computing device operable to perform the method of claim 2.

20. The apparatus of claim 19, in which the apparatus comprises at least one of:
an electronic system for conducting electronic trading, and
an electronic system for posting at least one of trade prices and quotes.

21. The apparatus of claim 19, in which the computing device is further operable to receive the market data from at least one of:
one or more data vendors,
one or more electronic systems for conducting electronic trading, and
one or more electronic systems for posting at least one of trade prices and quotes.
